(19) United States
(12) Patent Application Publication
(10) Pub. No.: US 2006/0025107 A1
(43) Pub. Date: Feb. 2, 2006

(54) Portable-terminal usage management method and portable terminal using the method

(76) Inventors: Tomokazu Makino, Yokohama (JP); Norihito Nishimoto, Yokohama (JP); Yoshimasa Sekiya, Yokohama (JP); Katunari Togasaki, Yokohama (JP); Masayosi Kamada, Yokohama (JP); Kazuya Jimbo, Yokohama (JP); Mitsuhiro Sato, Yohohama (JP); Harutaka Tanaka, Yokohama (JP); Satoshi Kanekiyo, Yokohama (JP); Hiroaki Kiyota, Yokohama (JP)

Correspondence Address: KATTEN MUCHIN ROSENMAN LLP, 575 MADISON AVENUE, NEW YORK, NY, 10022-2585, US

(21) Appl. No.: 10/984,646

(22) Filed: Nov. 8, 2004

(30) Foreign Application Priority Data
Jul. 28, 2004 (JP) 2004-220633

(51) Int. Cl. H04M 11/00

(52) U.S. Cl. 455/405; 455/407

(57) ABSTRACT

In a portable-terminal usage management method, log distribution conditions are downloaded from an administrative function module to one of a plurality of portable terminals. One of a plurality of communication log storage parts is selected in accordance with the log distribution conditions whenever one of the plurality of portable terminals starts communication. A communication log related to the communication started by the one of the plurality of portable terminals is stored into the selected one of the plurality of communication log storage parts.

### CROSS-REFERENCE TO RELATED APPLICATIONS

This application is based upon and claims the benefit of priority from Japanese Patent Application No. 2004-220633, filed on Jul. 28, 2004, the entire contents of which are herein incorporated by reference.

### BACKGROUND OF THE INVENTION

1. Field of The Invention

The present invention generally relates to a portable-terminal usage management method and portable terminal, and more particularly, to a method of management of portable-terminal usage and a portable terminal using the method.

2. Description of The Related Art

When using the portable terminals, such as mobile phones or PHS, for public use in the corporation or company, the way to pay the communication charges for public use is that the corporation pays the communication charges for portable terminals which are contracted with the communication carrier by the corporation and lent to the users or employees, or that the corporation pays the communication charges for portable terminals which are contracted with the communication carrier individually by the users or employees.

For example, Japanese Laid-Open Patent Application Nos. 07-245781, 10-285304 and 2002-354158 disclose the method of providing the accounting service to distribute the accounting location of the communication charge in the mobile communications system, such as the mobile phone or PHS.

Moreover, Japanese Laid-Open Patent Application No. 09-307666 discloses that the phone call history information containing the accounting information is divided in accordance with the purposes of use and stored in a memory of the portable terminal, and the stored information containing the accounting information according to the purposes of use is read from the memory and displayed by performing the retrieval operation on the basis of the purposes of use.

However, in the case of the method of lending the portable terminal of the corporation contract to the user, the portable terminal of the corporation contract is shared by two or more users, and it is difficult to check whether the portable terminal is used for private use by such users. The checking procedures such as ordering the specification of the communication charge from the communication carrier, and asking each user of the contents of the charged communications will be troublesome.

There is no effective method of preventing the private use of the portable terminal of the corporate contract by the individual users except appealing to their moral, and it is difficult to make the individual users pay the communication charge.

Moreover, in the case of the method of providing the accounting service to distribute the accounting location of the communication charge in the mobile communications system wherein the corporation pays a part of the communication charge for the portable terminal of the individual contract, the only method to prove the public use of the portable terminal of the individual contract is to submit the specification of the user individual's communication charge to the corporation. In this case, the communication charge of that portable terminal for the private use will also be visible to the corporation. Such method is not realistic. There has been no choice for the corporation to pay the charge based on the user's reporting.

Moreover, in the case of the method of providing the accounting service to distribute the communication charge for the portable terminal, disclosed in Japanese Laid-Open Patent Application Nos. 07-245781, 10-285304 and 2002-354158, the prerequisite for such a case is to make a contract of a plurality of communication lines, and it is necessary that the function is installed in the equipment of the communication carrier. It is difficult to provide easy-to-use service suited to the use form of the portable terminals in each corporation, and the management method related to the payment of the communication charge.

Furthermore, the method of dividing the phone call history information containing the accounting information in accordance with the purposes of use and storing the same in the memory of the portable terminal, disclosed in Japanese Laid-Open Patent Application No. 09-307666, becomes difficult to perform when a large number of portable terminals are applied. If a large number of portable terminals are applied, much time and effort will be needed to set up the software which divides the phone call history information containing the accounting information in accordance with the purposes of use and stores the same in the memory in each of the portable terminals. In addition, there is the problem in that the alteration of the communication log by unauthorized persons cannot be prevented.

### SUMMARY OF THE INVENTION

An object of the present invention is to provide an improved portable-terminal usage management method and portable terminal in which the above-mentioned problems are eliminated.

Another object of the present invention is to provide a portable-terminal usage management method in which the time and effort needed to set up the log distribution conditions in the portable terminal is minimized, the alteration of the log distribution conditions by unauthorized persons can be prevented, and the usage of the portable terminal on a particular-use basis can be managed.

Another object of the present invention is to provide a portable terminal using a method of management of portable-terminal usage in which the time and effort needed to set up the log distribution conditions in the portable terminal is minimized, the alteration of the log distribution conditions by unauthorized persons can be prevented, and the usage of the portable terminal on a particular-use basis can be managed.

The above-mentioned objects of the present invention are achieved by a portable-terminal usage management method comprising the steps of: downloading log distribution conditions from an administrative function module to one of a plurality of portable terminals; selecting one of a plurality of communication log storage parts in accordance with the log distribution conditions whenever one of the plurality of portable terminals starts communication; and storing a communication log related to the communication started by the one of the plurality of portable terminals, into the selected one of the plurality of communication log storage parts.

The above-mentioned objects of the present invention are achieved by a portable terminal comprising: a download part downloading log distribution conditions from an administrative function module to the portable terminal; a plurality of communication log storage parts each storing a communication log; a log distribution control part selecting one of the plurality of communication log storage parts in accordance with the log distribution conditions whenever the portable terminal starts communication; and a log recording part storing a communication log related to the communication started by the portable terminal, into the selected one of the plurality of communication log storage parts.

The above-mentioned portable terminal of the invention may be configured to further comprise a log acquisition part which selects one of the plurality of communication log storage parts in response to a log retrieval request, acquires a communication log from the selected one of the plurality of communication log storage parts, and outputs the acquired communication log. According to the above-mentioned invention, it is possible to output the usage of the portable terminal on a particular-use basis.

The above-mentioned portable terminal of the invention may be configured so that the log distribution conditions comprise a receiver list in which a plurality of phone numbers identifying a plurality of receivers and the communication log storage parts corresponding to the plurality of receivers respectively are registered, and the log distribution control part is provided to select one of the plurality of communication log storage parts by performing retrieval of the receiver list using a phone number of a particular receiver. According to the above-mentioned invention, it is possible to output the usage of the portable terminal on a receiver basis.

The above-mentioned portable terminal of the invention may be configured so that the log distribution conditions comprise an available-time list in which an available time and one of the communication log storage parts corresponding to the available time are registered, and the log distribution control part is provided to select one of the plurality of communication log storage parts by performing retrieval of the available-time list using a communication start/end time. According to the above-mentioned invention, it is possible to select one of the plurality of communication log storage parts on a communication-time basis.

According to the present invention, it is possible to minimize the time and effort needed to set up the log distribution conditions in the portable terminal, prevent the alteration of the log distribution conditions by unauthorized persons, and manage the usage of the portable terminal on a particular-use basis.

### BRIEF DESCRIPTION OF THE DRAWINGS

Other objects, features and advantages of the present invention will be apparent from the following detailed description when read in conjunction with the accompanying drawings.

FIG. 1 is a block diagram showing the functional composition of the portable terminal in the preferred embodiment of the invention.

FIG. 2 is a sequence diagram for explaining a first embodiment of the log storing processing in the portable-terminal usage management method of the invention.

FIG. 3 is a diagram showing an example of the receiver list.

FIG. 4 is a diagram showing an example of the log distribution conditions.

FIG. 5 is a diagram showing an example of the communication log.

FIG. 6 is a sequence diagram for explaining a second embodiment of the log storing processing in the portable-terminal usage management method of the invention.

FIG. 7 is a sequence diagram for explaining a third embodiment of the log storing processing in the portable-terminal usage management method of the invention.

FIG. 8 is a diagram showing an example of the available-time list.

FIG. 9 is a diagram showing an example of the communication log.

FIG. 10 is a sequence diagram for explaining an embodiment of the log display processing in the portable-terminal usage management method of the invention.

FIG. 11 is a diagram showing an example of the log retrieval request setting screen.

FIG. 12 is a diagram showing an example of the log display screen.

FIG. 13 is a diagram showing an example of the log display screen.

FIG. 14 is a sequence diagram for explaining an embodiment of the encrypt/decrypt key creation processing in the portable-terminal usage management method of the invention.

FIG. 15 is a sequence diagram for explaining an embodiment of the log encryption processing in the portable-terminal usage management method of the invention.

FIG. 16 is a sequence diagram for explaining an embodiment of the log encryption processing in the portable-terminal usage management method of the invention.

FIG. 17 is a sequence diagram for explaining an embodiment of the log-distribution-condition encryption processing in the portable-terminal usage management method of the invention.

FIG. 18 is a sequence diagram for explaining an embodiment of the log distribution processing in the portable-terminal usage management method of the invention.

### DETAILED DESCRIPTION OF PREFERRED EMBODIMENTS

A description will now be given of the preferred embodiments of the present invention with reference to the accompanying drawings.

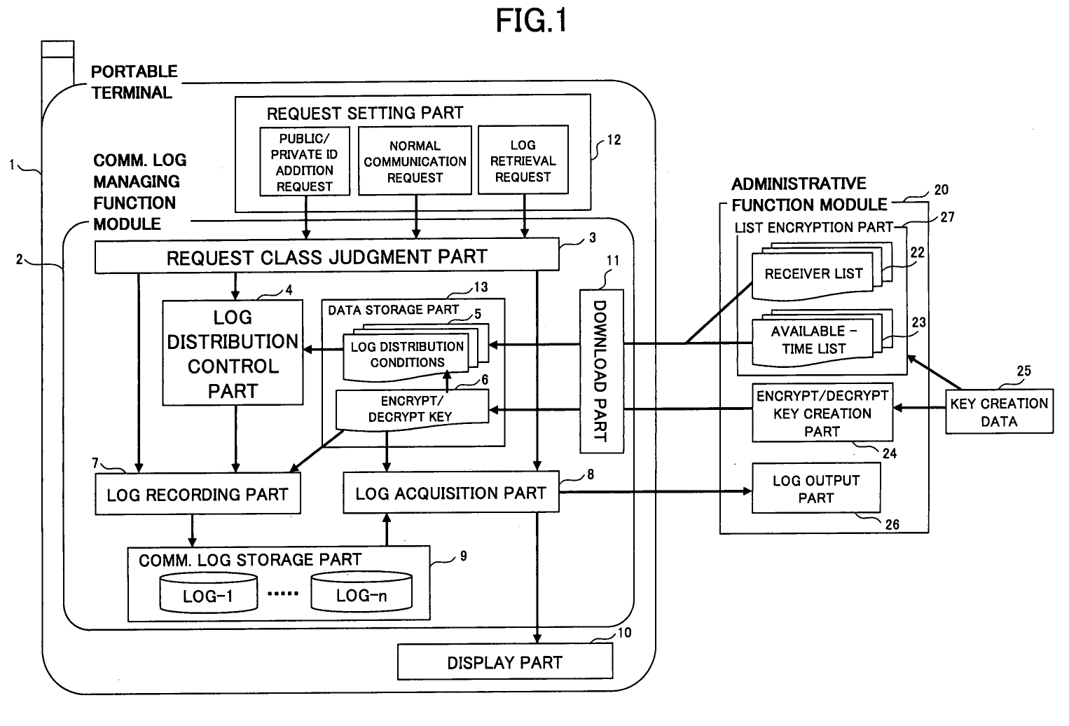

FIG. 1 shows the functional composition of the portable terminal in the preferred embodiment of the invention.

As shown in FIG. 1, the portable terminal 1 comprises the communication log managing function module 2, the request setting part 12 which operates in response to the operation of the user of the portable terminal 1 and transmits the various requests to the communication log managing function module 2, and the display part 10 which displays the communication logs stored in the portable terminal 1 and others.

In the communication log managing function module 2, the request class judgment part 3 judges the class of each of the various requests received from the request setting part 12. The log distribution control part 4 controls the distribution of the communication logs based on the log distribution conditions 5 which is acquired from the administrative function module 20. The encrypt/decrypt key 6 is acquired from the administrative function module 20, and it is supplied to both the log recording part 7 and the log acquisition part 8.

The log recording part 7 stores the communication logs, received from the request class judgment part 3, into any of the plurality of log storage locations (log-1, . . . , log-n) of the communication log storage part 9 in accordance with the distribution control of the log distribution control part 4.

The log acquisition part 8 acquires the communication log from the communication log storage part 9, and supplies the communication log to the administrative function module 20 or the display part 10.

The download part 11 acquires the list of the log distribution conditions 5 and the encrypt/decrypt key 6 which are supplied from the administrative function module 20, and stores them in the data storage part 13.

The administrative function module 20 is constituted by, for example, a personal computer. The receiver list 22 in the administrative function module 20 is a list of the phone numbers of the receivers which are recognized as the receivers for particular business uses by the corporation or company concerned. The receiver list 22 is set up by the administrator of the administrative function module 20.

Moreover, the available-time list 23 is a list of the available time of the portable terminal which is recognized as the use conditions of the portable terminal for particular business uses by the corporation or company concerned. The available-time list 23 is set up by the administrator of the administrative function module 20.

The encrypt/decrypt key creation part 24 receives the key creation information 25 which is used to identify the portable terminal 1 or the user of the portable terminal 1 by the administrator, and creates the encrypt/decrypt key for encryption and decryption of the communication log based on the received key creation information 25.

The log output part 26 outputs the communication logs supplied from the log acquisition part 8 of the portable terminal 1. The list encryption part 27 encrypts the log distribution conditions, such as the receiver list 22 or the available-time list 23.

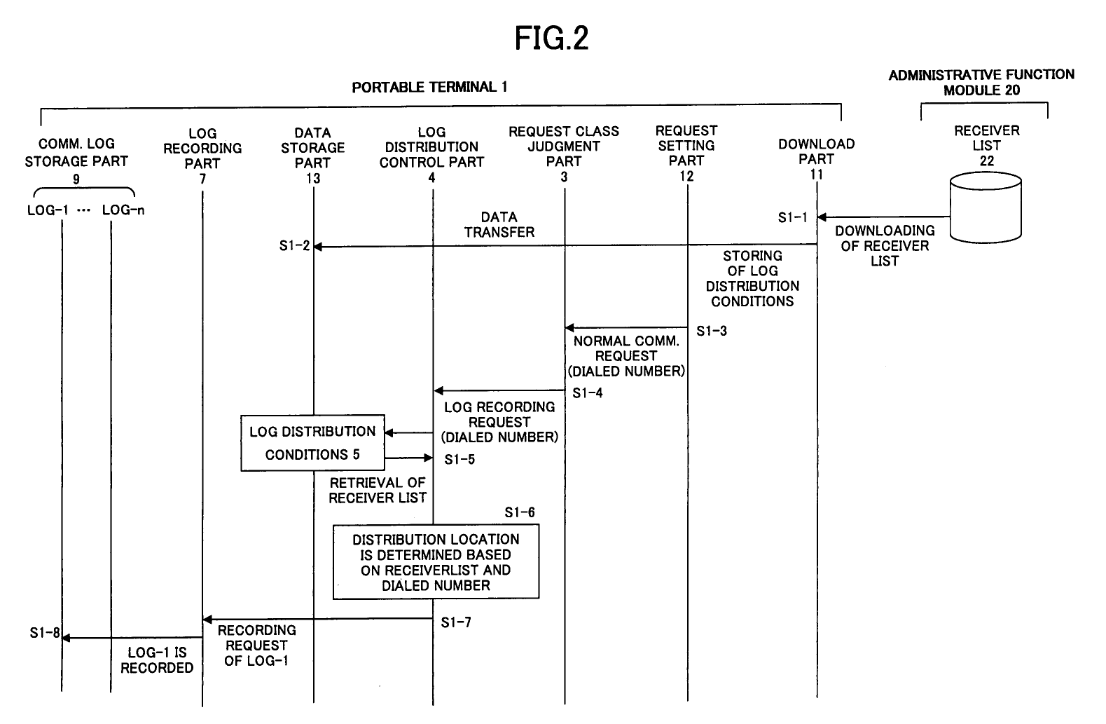

FIG. 2 is a sequence diagram for explaining the first embodiment of the log storing processing in the portable-terminal usage management method of the invention.

As shown in FIG. 2, upon starting of the log storing processing, the portable terminal 1 receives the receiver list 22 from the administrative function module 20 through the download part 11 (S1-1). The download part 11 of the portable terminal 1 stores the receiver list 22 in the data storage part 13 as the log distribution conditions 5 (S1-2).

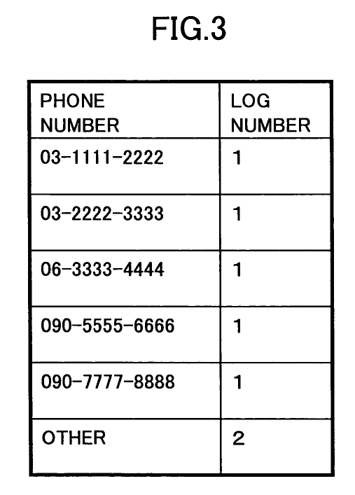

FIG. 3 shows an example of the receiver list 22. When the administrator performs addition/change/deletion of any items of the receiver list 22 of FIG. 3 including the phone number (or IP address) and the log number which indicates the log storage location, the administrator delivers the updated receiver list 22 to the portable terminal 1. Moreover, the administrator delivers the updated software to the portable terminal 1 in the case of the bug elimination of the software or the functional addition.

In the receiver list of FIG. 3, the log number “1” is assigned for the receivers (the phone numbers) which are specified beforehand by the administrator, and the log number “2” is assigned for the receivers (the phone numbers) which are unspecified.

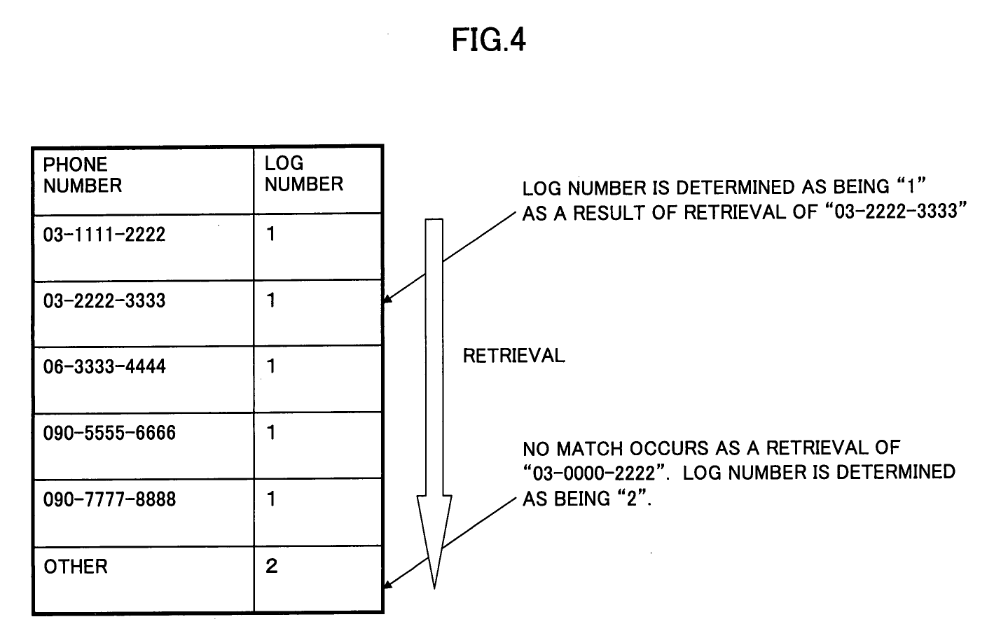

FIG. 4 shows an example of the log distribution conditions. The receiver list 22 is stored in the data storage part 13 of the portable terminal 1 as the log distribution conditions 5 as shown in FIG. 4.

In addition, there are some methods of delivering the receiver list 22 and the software to the portable terminal 1. The first method is to connect the administrative function module 20 with the download part 11 of each of the portable terminals 1, and deliver the receiver list 22 and the software to each portable terminal 1. The second method is that the administrative function module 20 accesses the portable terminals 1 of concern through the network and delivers the receiver list 22 and the software to all the portable terminals 1 collectively. The third method is that each of the portable terminals 1 accesses the Web server, connects to the administrative function module 20 via the Web server, and performs downloading of the receiver list 22 and the software from the administrative function module 20.

In the log storing processing of FIG. 2, the normal communication request is notified to the request class judgment part 3 with the dialed number through the request setting part 12 in response to the operation of the user of the portable terminal 1 (S1-3). The request class judgment part 3 notifies the log recording request to the log distribution control part 4 with the dialed number (S1-4).

The log distribution control part 4 retrieves the log distribution conditions 5 (or the receiver list) of the data storage part 13 by using the notified dialed number (S1-5). The log distribution control part 4 determines the distribution location of the communication log based on the log distribution conditions (or the receiver list) and the dialed number (S1-6).

The log recording part 7 edits the communication log from the log distribution control part 4, and sends the log recording request to the communication log storage part 9 (S1-7). Thereby, the communication log is recorded in the communication log storage part 9 (S1-8).

For example, suppose the case in which the user of the portable terminal 1 accesses the phone number “03-2222-3333”. In this case, the request setting part 12 notifies the normal communication request to the request class judgment part 3 with the dialed number (03-2222-3333).

After the normal communication request is received from the request setting part 12, the request class judgment part 3 edits the communication log, and sends the log recording request to the log distribution control part 4 with the dialed number (03-2222-3333).

The log distribution control part 4 retrieves the log distribution conditions 5 (or the receiver list) of the data storage part 13 for the dialed number (03-2222-3333) as shown in FIG. 4, and determines the log storage location (log number “1”) based on the log number at which a match between the dialed number and the phone number of the receiver list occurs.

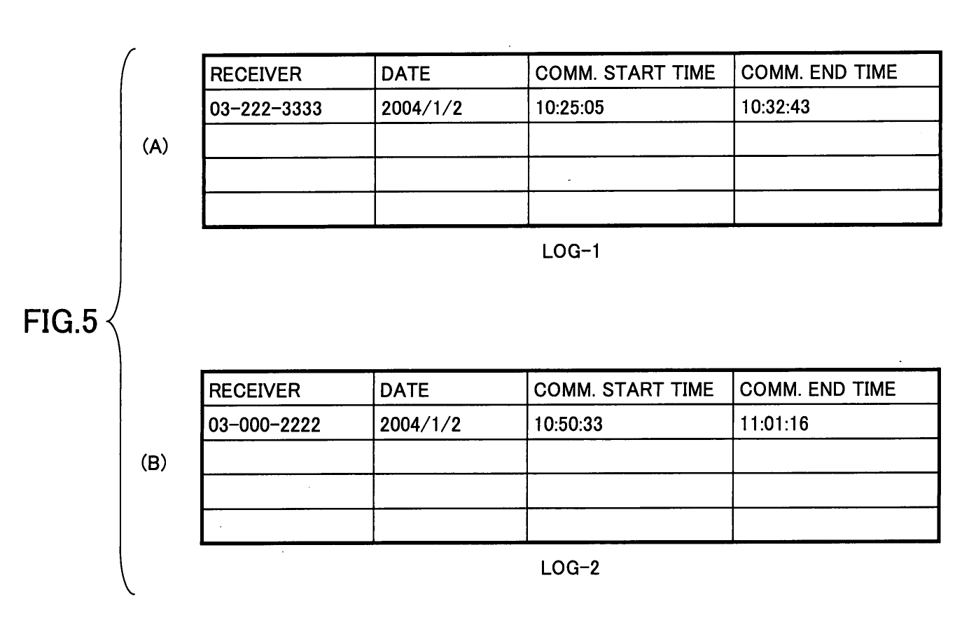

The log distribution control part 4 notifies the log recording request to the log recording part 7 with the log storage location (log-1). FIG. 5 shows an example of the communication log. The log recording part 7 records the communication log at the selected log storage location (log-1) of the communication log storage part 9 as indicated by (A) in FIG. 5.

Moreover, suppose the case in which the user of the portable terminal 1 accesses the phone number “03-0000-2222”. In this case, the dialed number (03-0000-2222) does not match the log distribution condition 5 of the data storage part 13. The log distribution control part 4 in the present embodiment determines the log storing location (log 2) as a result of the retrieval of the log distribution conditions 5 (or the receiver list) of the data storage part 13 for the dialed number (03-0000-3333) as shown in FIG. 4.

Therefore, the log distribution control part 4 sends the log recording request to the log recording part 7 with the log storage location (log-2). The log recording part 7 records the communication log at the selected log storage location (log-2) of the communication log storage part 9 as indicated by (B) in FIG. 5.

According to the present embodiment, the receiver list 22 created by the administrative function module 20 is downloaded to two or more portable terminals 1, and it is possible to easily set up the log distribution conditions 5 common to the portable terminals 1, and the time and effort can be minimized. Moreover, it is possible to prevent the input error or the alteration of the log distribution conditions 5 on each of the portable terminals 1.

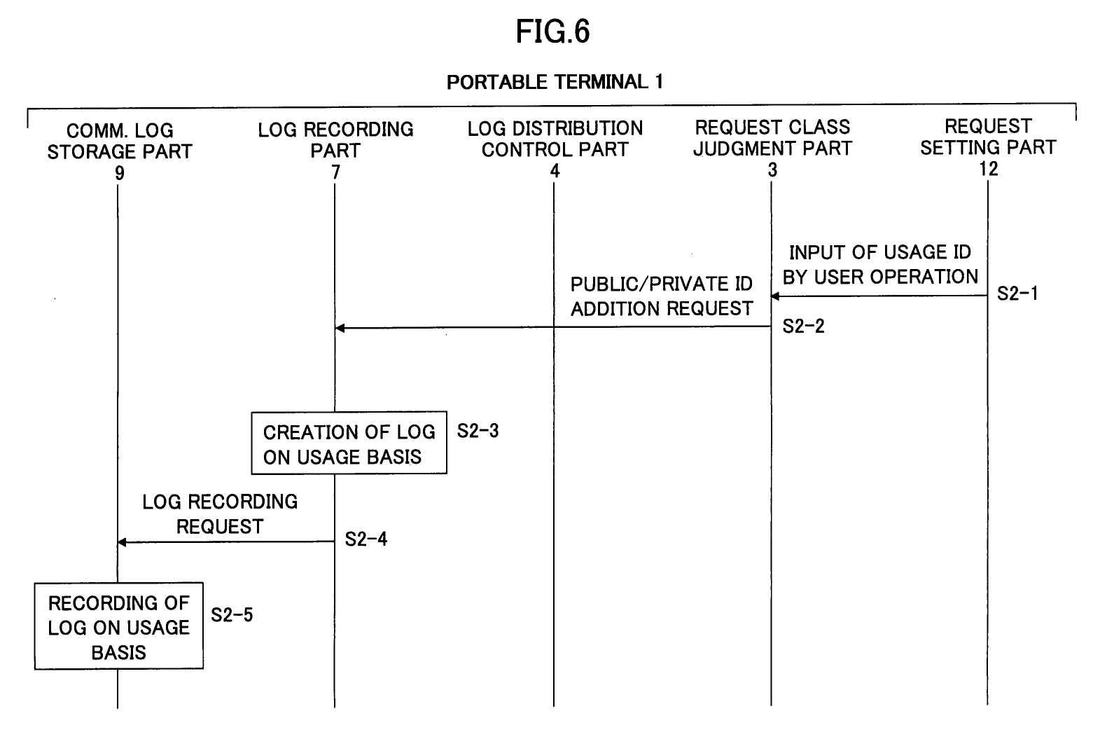

FIG. 6 is a sequence diagram for explaining the second embodiment of the log storing processing in the portable-terminal usage management method of the invention.

In this embodiment, the user of the portable terminal 1 inputs the usage ID, which is used to specify the business-case public use or the private use, on the portable terminal 1 in order to specify the communication usage.

As shown in FIG. 6, the request setting part 12 receives the communication usage ID which is inputted by the user of the portable terminal 1, and sends the log recording request to the request class judgment part 3 with the usage ID (S2-1).

The request class judgment part 3 notifies the log recording request to the log recording part 7 with the usage ID which is assigned for each of the business-case public use and the private use (S2-2).

The log recording part 7 creates a communication log based on the usage ID inputted with the log recording request and the use information related to the communication performed by the user of the portable terminal 1 (S2-3). The log recording part 7 sends the log recording request to the communication log storage part 9 with the created communication log (S2-4), and the created communication log is recorded in the communication log storage part 9 corresponding to the usage ID (S2-5).

In the present embodiment, when it is exceptionally needed for the user of the portable terminal 1 to communicate with a receiver, which is not included in the predetermined receiver list, the communication log storage location which is suited to such communication purpose is chosen by the user input operation.

Before starting such communication on the portable terminal 1, the user inputs the specific phone number and the specific communication usage ID by pressing the operation button of the portable terminal 1, and then the communication is started. The portable terminal 1 determines the log number based on the inputted usage ID, and records the communication log at the log storage location, corresponding to the determined log number, in the communication log storage part 9.

According to the present embodiment, it is possible to attain the recording of the communication logs on a particular-usage basis with respect to any receiver which is not included in the predetermined receiver list.

Moreover, it is also possible to perform the usage selection on the display screen of the display part 10 instead of specifying the communication usage ID.

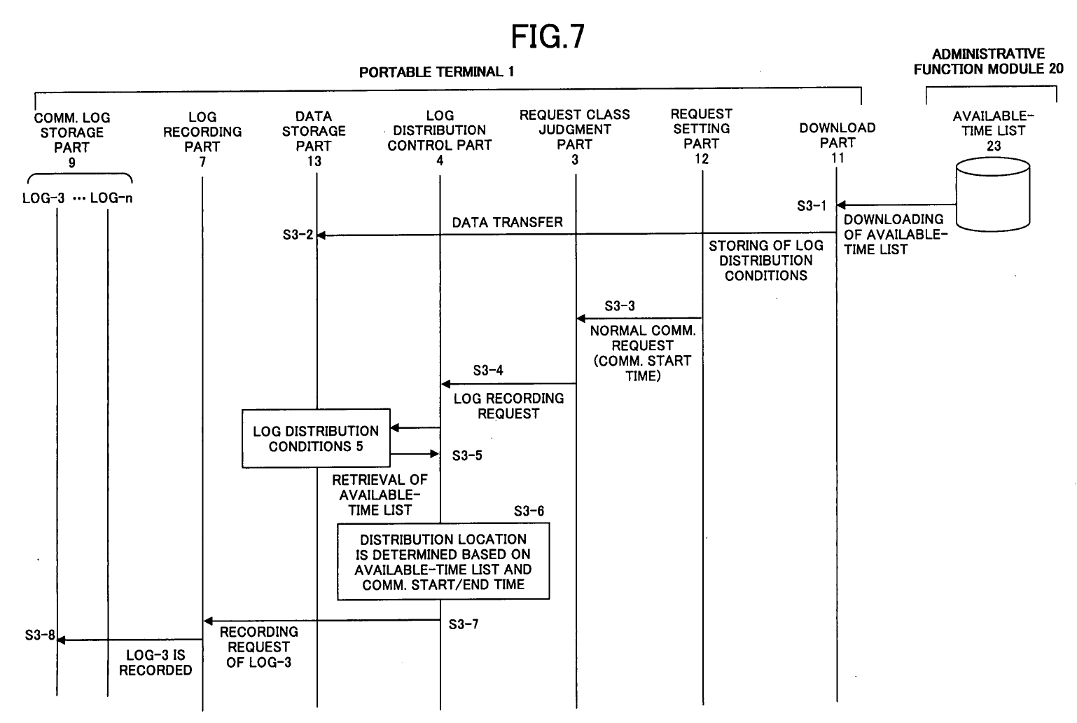

FIG. 7 is a sequence diagram for explaining the third preferred embodiment of the log storing processing in the portable-terminal usage management method of the invention.

In this embodiment, when keeping track of the usage of the portable terminal 1, the communication logs of the portable terminal 1 with respect to a specific time zone are distributed by using the available-time list 23 which is created by the administrative function module 20.

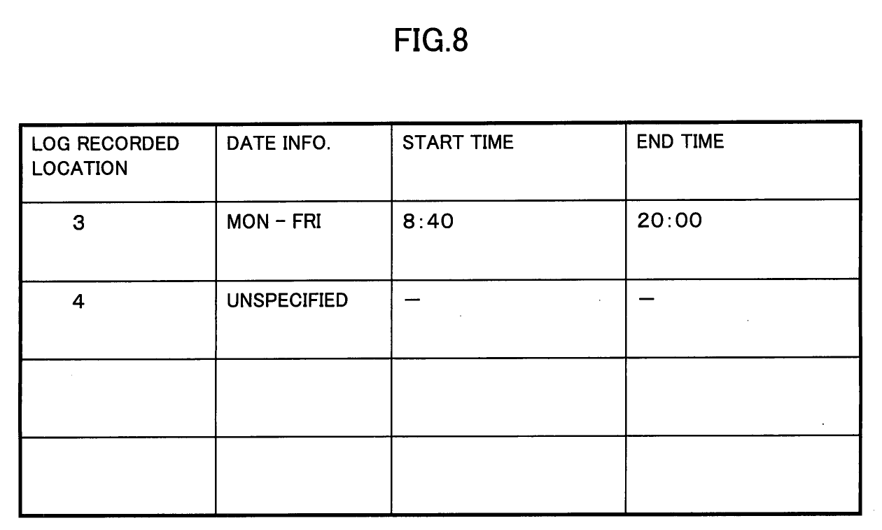

As shown in FIG. 7, the available-time list 23 shown in FIG. 8 is created by the administrative function module 20, and it is downloaded from the administrative function module 20 to the portable terminal 1 by the download part 11 (S3-1). The download part 11 stores the available-time list 23 in the data storage part 13 of the portable terminal 1 as the log distribution conditions 5 (S3-2).

In the available-time list of FIG. 8, in accordance with to the actual results of the working hours of the user of the portable terminal 1, the log number “3” is assigned for the communications of 8:40-20:00 on each working day between Monday and Friday, and the log number “4” is assigned for the communications of unspecified hours outside the specified time zone.

In addition, there are some methods of distribution of the available-time list 23 to the portable terminal 1. The first method is to connect the administrative function module 20 with the download part 11 of each of the portable terminals 1, and distribute the available-time list 23 to each portable terminal 1. The second method is that the administrative function module 20 accesses the portable terminals 1 of concern through the network and distributes the available-time list 23 to all the portable terminals 1 collectively. The third method is that each of the portable terminals 1 accesses the Web server, connects to the administrative function module 20 via the Web server, and performs downloading of the available-time list 23 from the administrative function module 20.

In response to the operation of the user of the portable terminal 1, the normal communication request is notified to the request class judgment part 3 through the request setting part 12 (S3-3). The request class judgment part 3 notifies the log recording request to the log distribution control part 4 with a communication start time (S3-4).

In response to the log recording request, the log distribution control part 4 searches the log distribution conditions 5 (or the available-time list) of the data storage part 13 by using the notified communication start time (S3-5). The log distribution control part 4 determines the distribution location of the communication log based on the log distribution conditions 5 and the communication start time (S3-6).

The log recording part 7 edits the communication log from the log distribution control part 4 and sends the log recording request to the log recording part 7 (S3-7).

In response to the log recording request, the log recording part 7 records the communication log in the communication log storage part 9 (S3-8).

For example, suppose the case in which the user of the portable terminal 1 performs a phone call for about 15 minutes after the communication start time 17:25 on Wednesday. In this case, it is within the specified time zone in the log distribution conditions 5 set up for the portable terminal 1, and the log distribution control part 4 notifies the log storage location (log-3) where the communication log should be recorded, to the log recording part 7 with the log recording request. Thus, the log recording part 7 records the communication log related to the phone call by the user of the portable terminal 1, at the notified log storage location (log-3) in the communication log storage part 9.

When the user of the portable terminal 1 performs a phone call for about 10 minutes after 22:30 on Saturday which falls in the unspecified hours in the available-time list 23 of the log distribution conditions 5, it is determined that the communication pertains to the “unspecified” cases, and the log storage location (log-4) is assigned. In this case, the log distribution control part 4 notifies the log storage location (log-4) where the communication log should be recorded, to the log recording part 7 with the log recording request. Thereby, the log recording part 7 records the communication log related to the phone call by the user of the portable terminal 1, at the selected log storage location (log 4) of the communication log storage part 9.

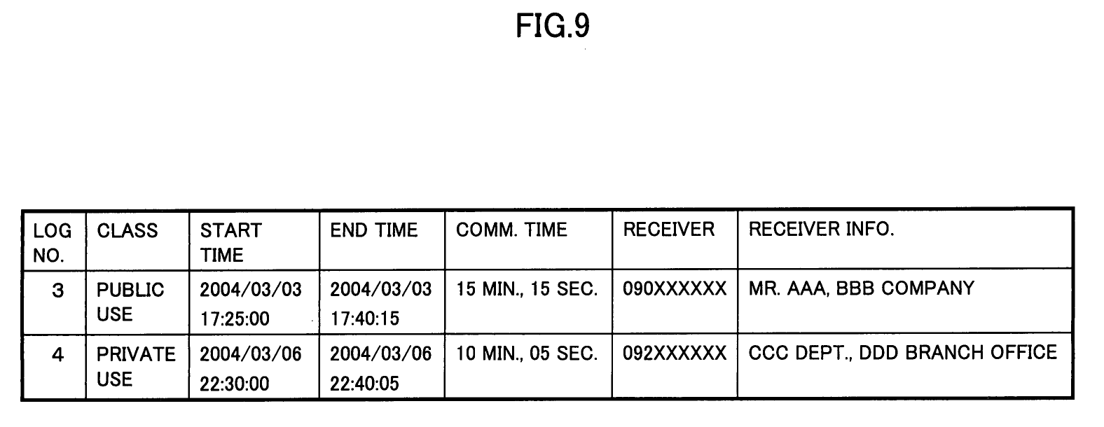

FIG. 9 shows an example of the communication log. If the communication start time falls within the specified time zone time in the available-time list 23, the communication log is stored at the log storage location (log-3) like the communication log indicated by the log number “3” in FIG. 9, even if it is the case where the communication end time of the phone call is postponed out of the specified time zone.

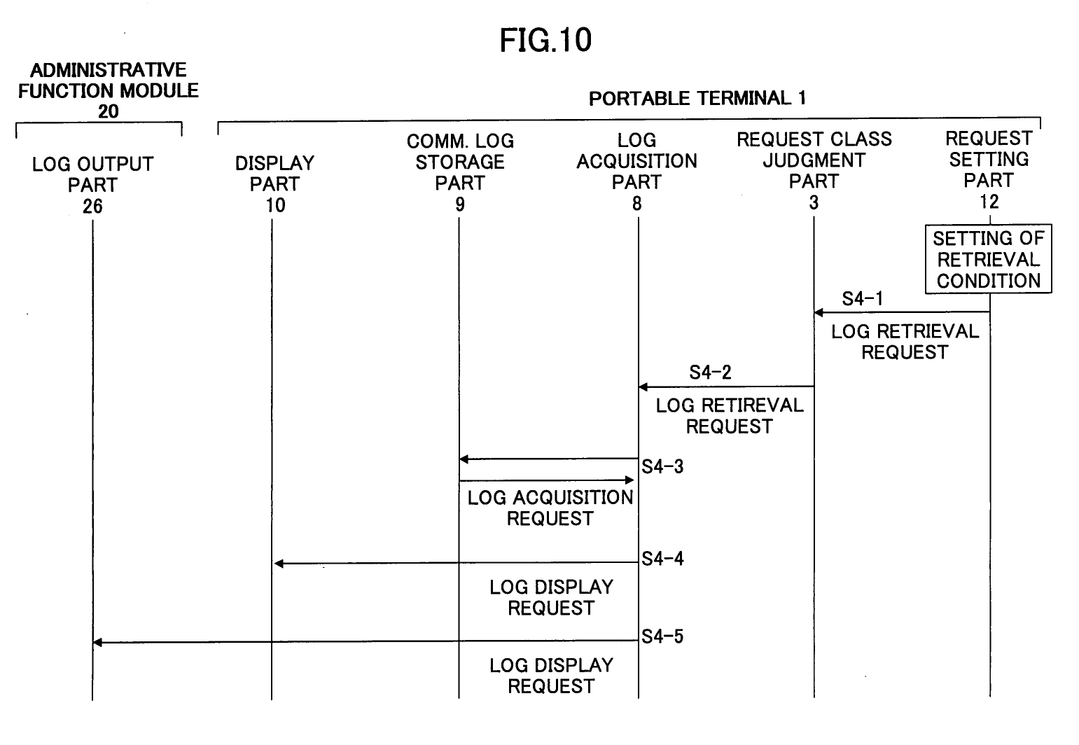

FIG. 10 is a sequence diagram for explaining the embodiment of the log display processing in the portable-terminal usage management method of the invention.

As shown in FIG. 10, when retrieving the communication log of the portable terminal 1, the log retrieval request is sent to the request class judgment part 3 by the request setting part 12 of the portable terminal 1 (S4-1).

The request class judgment part 3 determines whether the received request is the log retrieval request, and if it is the log retrieval request, the request class judgment part 3 notifies the log retrieval request to the log acquisition part 8 (S4-2).

In response to the log retrieval request, the log acquisition part 8 acquires the communication log from the communication log storage part 9 (S4-3). The log acquisition part 8 outputs the acquired communication log to the display part 10 of the portable terminal 1 (S4-4). Or the log acquisition part 8 outputs the acquired communication log to the log output part 26 provided in the administrative function module 20 (S4-5).

For example, when retrieving the communication log of the portable terminal 1, the user of the portable terminal 1 specifies the retrieval conditions, such as the class, the time and the receiver of the desired communication log, by performing the input operation on the portable terminal 1.

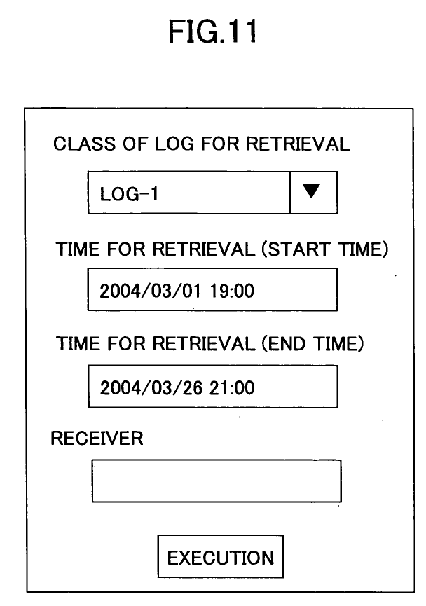

FIG. 11 shows an example of the log retrieval request setting screen. On the display screen of the display part 10 of the portable terminal 1, the setting of the retrieval conditions in which the class, the time (the communication start/end time) and the receiver are specified for the desired communication log is displayed as shown in FIG. 11.

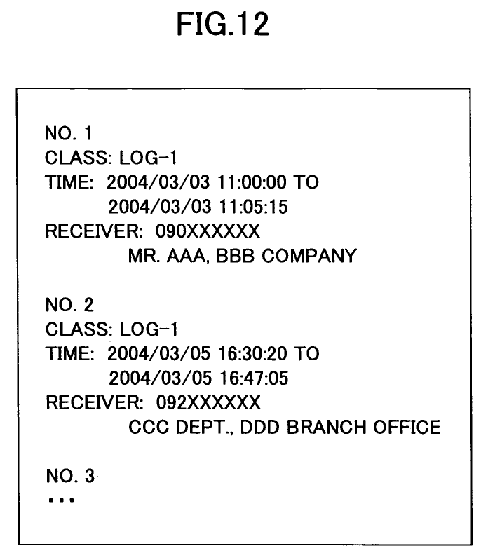

Next, in the portable terminal 1, it is determined whether the received request is the log retrieval request, and if it is the log retrieval request, the communication log is acquired based on the retrieval conditions as specified. FIG. 12 shows an example of the log display screen as a result of the log retrieval. As shown in FIG. 12, on the display screen of the display part 10 of the portable terminal 1, the resulting communication logs which match the retrieval conditions are displayed.

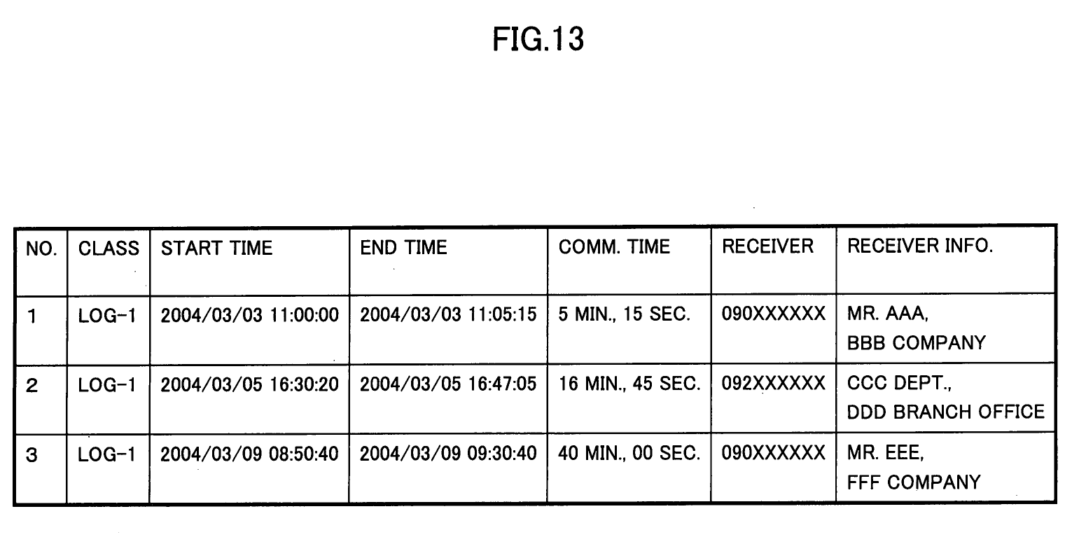

Moreover, it is also possible that the portable terminal 1 be connected with the log output part 26 of the administrative function module 20, and the resulting communication logs be displayed on the log output part 26 as shown in FIG. 13. FIG. 13 shows an example of the log display screen in this case.

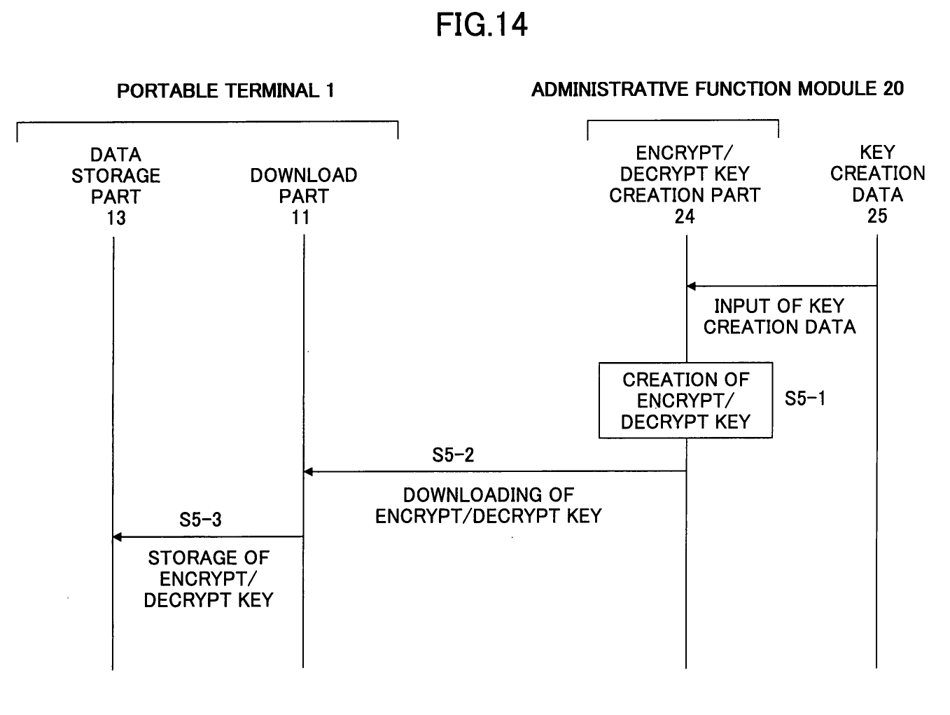

FIG. 14 is a sequence diagram for explaining the embodiment of the encrypt/decrypt key creation processing in the portable-terminal usage management method of the invention.

As shown in FIG. 14, when the key creation information 25, which is known to both the user of the portable terminal 1 and the administrator of the administrative function module 20, is inputted to the encrypt/decrypt key creation part 24 of the administrative function module 20, the encrypt/decrypt key creation part 24 creates the encrypt/decrypt key 6 (S5-1).

The encrypt/decrypt key 6 from the administrative function module 20 is downloaded to the portable terminal 1 through the download part 11 (S5-2), and it is stored in the data storage part 13 (S5-3).

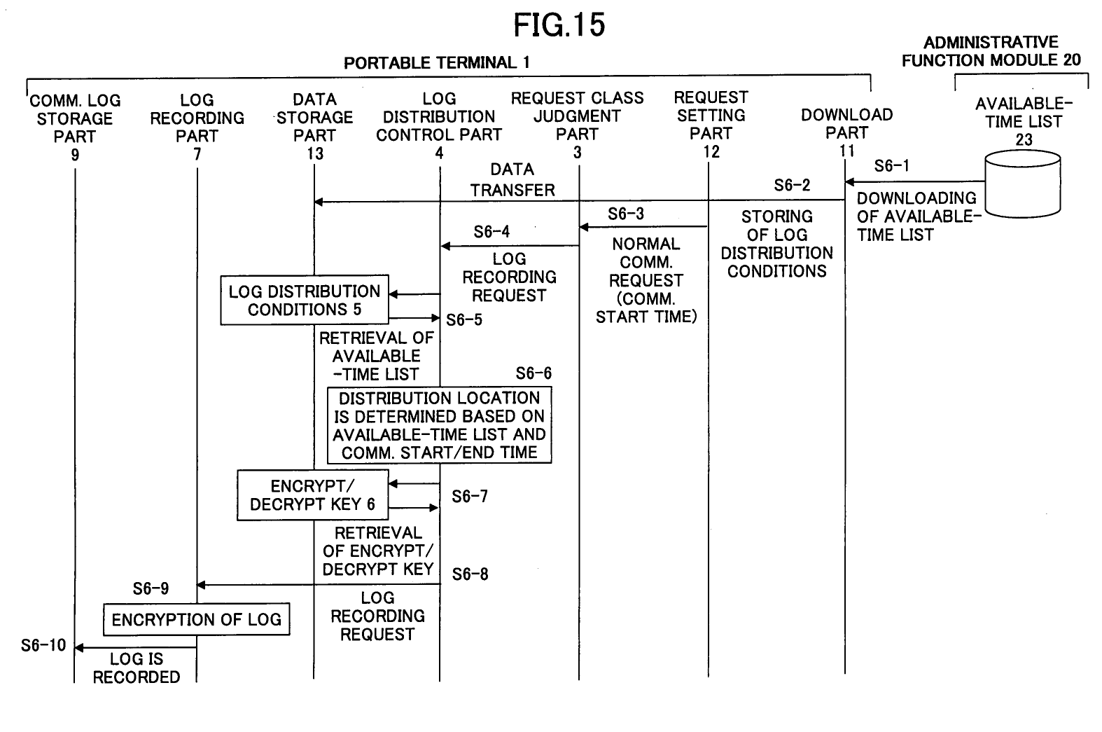

FIG. 15 is a sequence diagram for explaining the embodiment of the log encryption processing in the portable-terminal usage management method of the invention.

As shown in FIG. 15, the available-time list 23 as shown in FIG. 8 is created by the administrative function module 20 and downloaded to the portable terminal 1 by the download part 11 (S6-1). It is stored in the data storage part 13 of the portable terminal 1 as the log distribution conditions 5 (S6-2).

Next, the normal communication request is notified to the request class judgment part 3 through the request setting part 12 in response to the operation of the user of the portable terminal 1 (S6-3). The request class judgment part 3 notifies the log recording request to the log distribution control part 4 with a communication start time (S6-4).

The log distribution control part 4 retrieves the log distribution conditions 5 (or the available-time list) of the data storage part 13 by using the notified communication start time (S6-5). The log distribution control part 4 determines the distribution location of the communication log based on the available-time list and the communication start time (S6-6), acquires the encrypt/decrypt key 6 from the data storage part 13 (S6-7), and sends the recording request to the log recording part 7 with the encrypt/decrypt key 6 (S6-8).

The log recording part 7 edits the communication log from the log distribution control part 4, encrypts the communication log using the encrypt/decrypt key 6 (S6-9), and records the encrypted communication log in the communication log storage part 9 (S6-10).

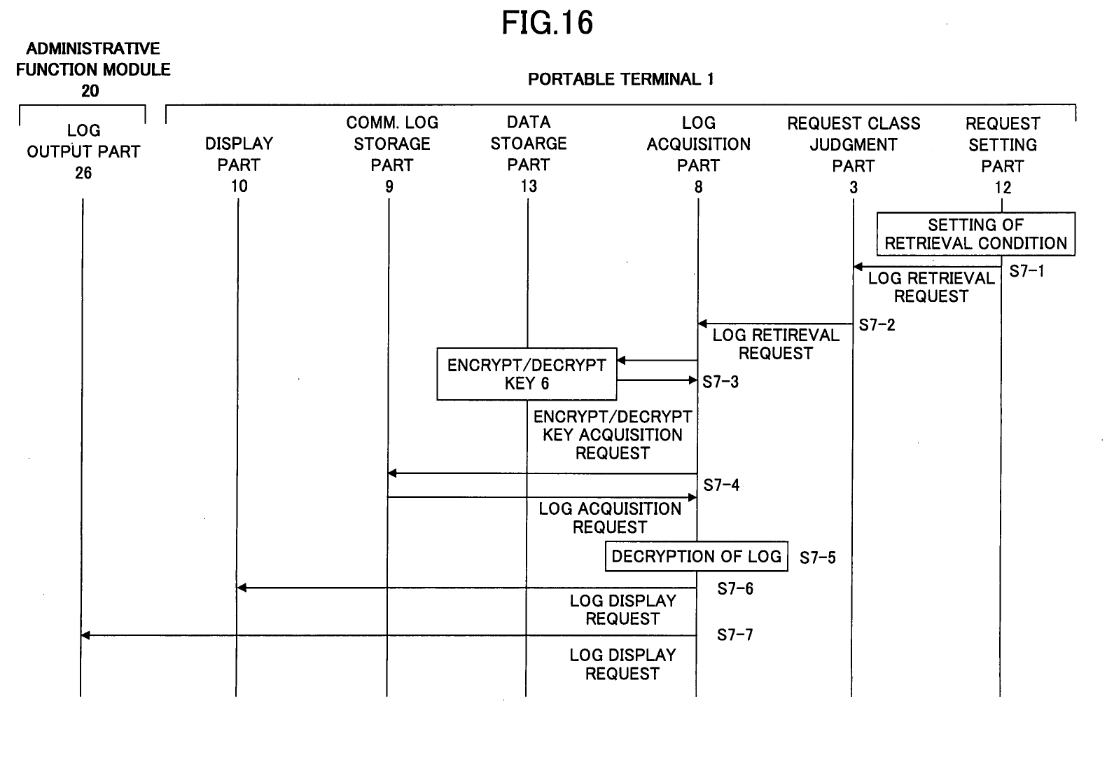

FIG. 16 is a sequence diagram for explaining the embodiment of the log encryption processing in the portable-terminal usage management method of the invention.

As shown in FIG. 16, when referring to the communication log of the portable terminal 1, the request setting part 12 of the portable terminal 1 sends the log retrieval request to the request class judgment part 3 (S7-1).

The request class judgment part 3 determines whether the received request is the log retrieval request, and if it is the log retrieval request, the request class judgment part 3 sends the log retrieval request to the log acquisition part 8 (S7-2).

In response to the received log retrieval request, the log acquisition part 8 acquires the encrypt/decrypt key 6 from the data storage part 13 (S7-3), acquires the communication log from the log storage part 9 (S7-4), and decrypts the communication log using the encrypt/decrypt key 6 (S7-5).

Next, the log acquisition part 8 outputs the decrypted communication log to the display part 10 of the portable terminal 1 with the log display request (S7-6). Or the log acquisition part 8 outputs the decrypted communication log to the log output part 26 of the administrative function module 20 with the log display request (S7-7).

For example, suppose the case of inputting the employee number of the employee B in the company A to the encrypt/decrypt key creation part 24 of the administrative function module 20 as the key creation information 25. In this case, the encrypt/decrypt key creation part 24 creates a unique encrypt/decrypt key corresponding to the portable terminal 1 held by the employee B, based on the inputted employee number.

The unique encrypt/decrypt key from the administrative function module 20 is downloaded to the portable terminal 1 held by the employee B. Encryption and decryption of any communication log related to the portable terminal 1 is carried out on the portable terminal 1 using the unique encrypt/decrypt key downloaded. Therefore, it is possible to prevent the alteration of the communication log by not only the employee B who is the user of the portable-terminal 1 but also any external third person.

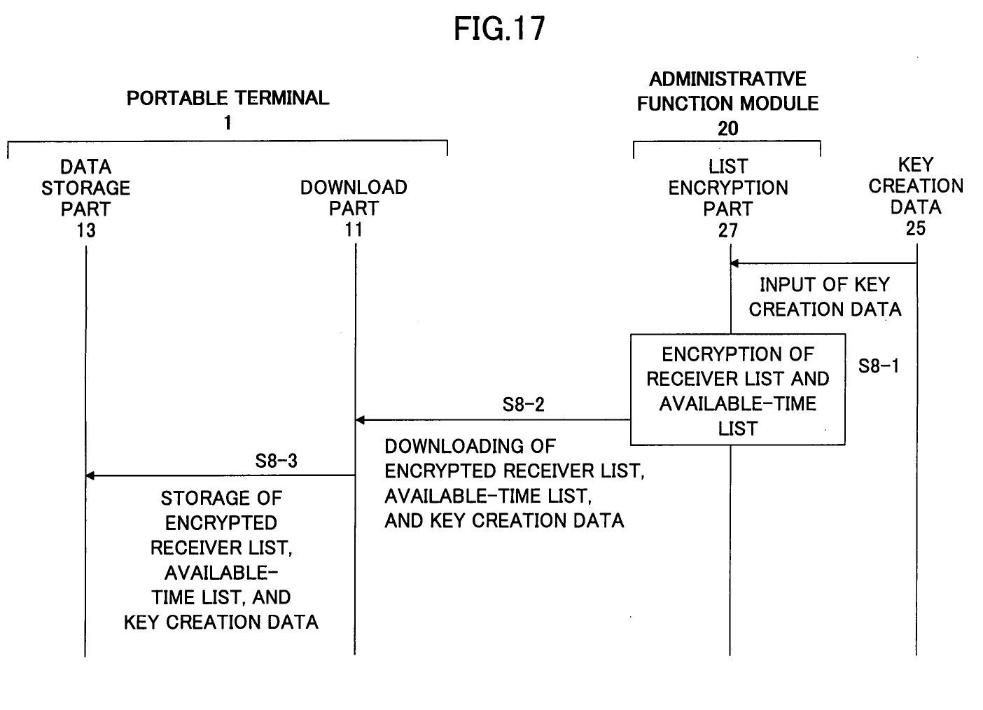

FIG. 17 is a sequence diagram for explaining the embodiment of the log-distribution-condition encryption processing in the portable-terminal usage management method of the invention.

As shown in FIG. 17, when the key creation information 25 which is known to both the user of the portable terminal 1 and the administrator of the administrative function module 20 is inputted to the administrative function module 20, the list encryption part 27 creates the encrypted log distribution conditions 5 which include the encrypted receiver list 22 and the encrypted available-time list 23 (S8-1). The encrypted log distribution conditions 5 mentioned above are created using the encrypt/decrypt key received from the encrypt/decrypt key creation part 24.

The download part 11 downloads the encrypted log distribution conditions 5 (including the encrypted receiver list and the encrypted available-time list) from the administrative function module 20 to the portable terminal 1 (S8-2). The encrypted log distribution conditions 5 are stored in the data storage part 13 through the download part 11 (S8-3). At this time, the encrypt/decrypt key 6 which is created with the key creation information 25 is also stored in the data storage part 13 through the download part 11.

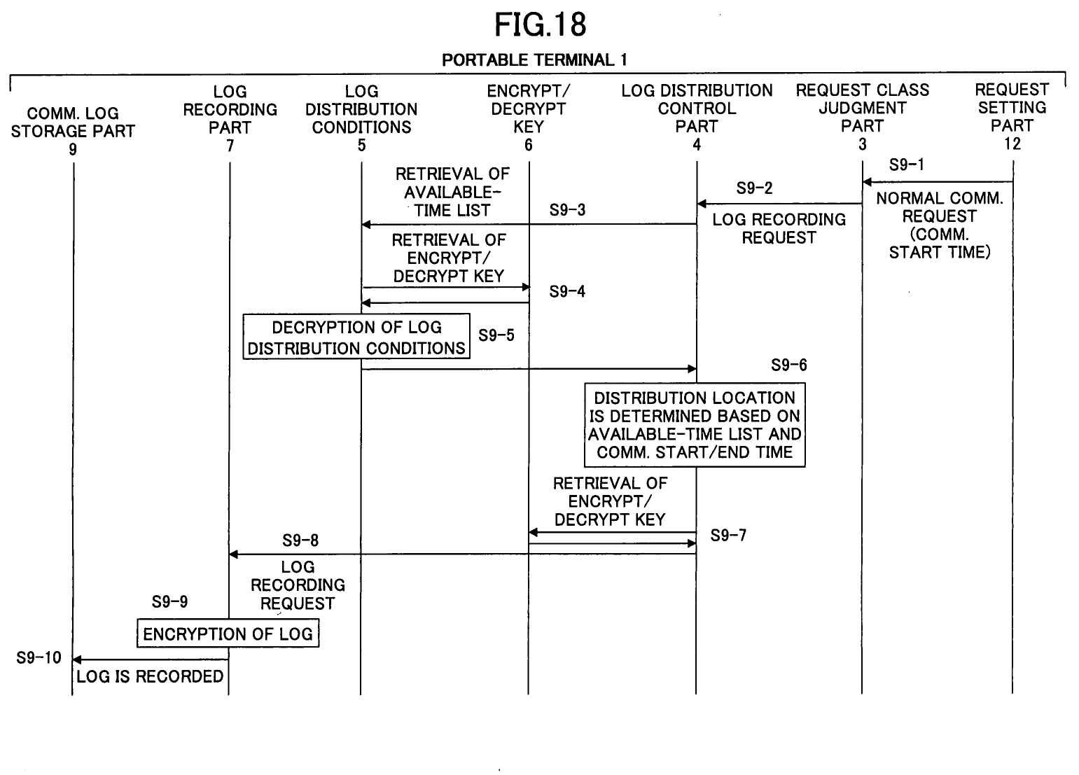

FIG. 18 is a sequence diagram for explaining the embodiment of the log distribution processing in the portable-terminal usage management method of the invention.

As shown in FIG. 18, the normal communication request is notified to the request class judgment part 3 through the request setting part 12 in response to the operation of the user of the portable terminal 1 (S9-1). The request class judgment part 3 notifies the log recording request to the log distribution control part 4 with a communication start time (S9-2).

In response to the log recording request, the log distribution control part 4 retrieves the log distribution conditions 5 (or the available-time list) of the data storage part 13 by using the notified communication start time (S9-3). The log distribution control part 4 acquires the encrypt/decrypt key 6 from the data storage part 13 (S9-4). The log distribution control part 4 decrypts the log distribution conditions 5 using the encrypt/decrypt key 6 (S9-5), so that the log distribution control part 4 acquires the decrypted log distribution conditions 5 (or the decrypted available-time list).

Next, the log distribution control part 4 determines the distribution location of the communication log based on the available-time list and the communication start time (S9-6). The log distribution control part 4 acquires the encrypt/decrypt key 6 from the data storage part 13 (S9-7), and sends the log recording request to the log recording part 7 with the encrypt/decrypt key 6 (S9-8).

The log recording part 7 edits the communication log from the log distribution control part 4, encrypts the communication log using the encrypt/decrypt key 6 (S9-9), and records the encrypted communication log in the communication log storage part 9 (S9-10).

For example, suppose the case of inputting the employee number of the employee B in the company A to the list encryption part 27 of the administrative function module 20 as the key creation information 25. In this case, the list encryption part 27 creates an encrypted unique log distribution conditions corresponding to the portable terminal 1 held by the employee B, using the encrypt/decrypt key which is created from the employee number by the encrypt/decrypt key creation part 26.

The encrypted unique log distribution conditions from the administrative function module 20 are downloaded to the portable terminal 1 held by the employee B. In the portable terminal 1, the encrypted log distribution conditions are decrypted using the encrypt/decrypt key 6 downloaded. Thereby, it is possible to prevent the alteration of the log distribution conditions by not only the employee B who is the user of the portable terminal 1 but also any external third person.

According to the present invention, it is possible to acquire the following effects on the management of the usage of the portable terminal 1 without modifying the communication equipment of the communication carrier.

It is possible to use the communication logs obtained according to the portable-terminal usage management method of the present invention as the information certifying the usage of the portable terminal 1, once agreement is reached between the corporation or company and the employees that the lists of the log distribution conditions are the receiver-related information accepted by the corporation as being for the business-case public use.

Moreover, when the portable-terminal usage management method of the present invention is applied to the portable terminal 1 which is lent to the employee, it is possible for the corporation or company to easily check whether the employee uses the portable terminal 1 for the private use or for the business-case public use.

Moreover, when the portable-terminal usage management method of the present invention is applied to the portable terminal 1 which is lent to the employee, it is possible for the corporation or company to keep track of the business-case public use of the employee's portable terminal 1 in detail. Thereby, it is possible for the corporation to proceed with the payment of the communication charge for the portable terminal 1 without ambiguity or mistake.

Furthermore, when the portable-terminal usage management method of the present invention is applied to the portable terminal 1 individually contracted with the communication carrier, it is possible for the user of the portable terminal 1 to submit to the corporation the communication logs stored in the portable terminal 1 and taken as a proof of the communication costs for the business-case use. In addition, it is possible for the user of the portable terminal 1 to submit only the necessary communication logs without making the private communication situation open to the corporation for which the user works as the employee.

In the above-described embodiments, the download part 11 corresponds to the download part in the claims, the communication log storage part 9 corresponds to the plurality of communication log storage parts in the claims, the log distribution control part 4 corresponds to the log distribution control part in the claims, the log recording part 7 correspond to the log recording part in the claims, and the log acquisition part 8 corresponds to the log acquisition part in the claims.

The present invention is not limited to the above-described embodiments, and variations and modifications may be made without departing from the scope of the present invention.

What is claimed is:

1. A portable-terminal usage management method comprising the steps of:
downloading log distribution conditions from an administrative function module to one of a plurality of portable terminals;
selecting one of a plurality of communication log storage parts in accordance with the log distribution conditions whenever one of the plurality of portable terminals starts communication; and
storing a communication log related to the communication started by said one of the plurality of portable terminals, into the selected one of the plurality of communication log storage parts.

2. A portable terminal comprising:
a download part downloading log distribution conditions from an administrative function module to the portable terminal;
a plurality of communication log storage parts each storing a communication log;
a log distribution control part selecting one of the plurality of communication log storage parts in accordance with the log distribution conditions whenever the portable terminal starts communication; and
a log recording part storing a communication log related to the communication started by the portable terminal, into the selected one of the plurality of communication log storage parts.

3. The portable terminal of claim 2 further comprising a log acquisition part selecting one of the plurality of communication log storage parts in response to a log retrieval request, acquiring a communication log from the selected one of the plurality of communication log storage parts, and outputting the acquired communication log.

4. The portable terminal of claim 2 wherein the log distribution conditions comprise a receiver list in which a plurality of phone numbers identifying a plurality of receivers and the communication log storage parts corresponding to the plurality of receivers respectively are registered, and the log distribution control part is provided to select one of the plurality of communication log storage parts by performing retrieval of the receiver list using a phone number of a particular receiver.

5. The portable terminal of claim 2 wherein the log distribution conditions comprise an available-time list in which an available time and one of the communication log storage parts corresponding to the available time are registered, and the log distribution control part is provided to select one of the plurality of communication log storage parts by performing retrieval of the available-time list using a communication start/end time.

6. The portable terminal of claim 3 wherein the log acquisition part is provided to output the communication log, acquired from the selected communication log storage part, to a display part of the portable terminal.

7. The portable terminal of claim 3 wherein the log acquisition part is provided to output the communication log, acquired from the selected communication log storage part, to the administrative function module.

8. The portable terminal of claim 2 wherein the download part is provided to download an encrypt/decrypt key from the administrative function module to the portable terminal, the log distribution control part is provided to encrypt the communication log using the encrypt/decrypt key, and the log recording part is provided to store the encrypted communication log into the selected communication log storage part.

9. The portable terminal of claim 8 further comprising a log acquisition part selecting one of the plurality of communication log storage parts in response to a log retrieval request, acquiring an encrypted communication log from the selected one of the plurality of communication log storage parts, and outputting the acquired communication log, wherein the log acquisition part is provided to output the communication log after the encrypted communication log which is acquired from the selected communication log storage part is decrypted using the encrypt/decrypt key.

10. The portable terminal of claim 8 wherein the download part is provided to download encrypted log distribution conditions and a corresponding encryption key from the administrative function module to the portable terminal, and the log distribution control part is provided to receive the log distribution conditions which are decrypted from the encrypted log distribution conditions using the encryption key.
